(19) United States
(12) Patent Application Publication
(10) Pub. No.: US 2009/0125433 A1
(43) Pub. Date: May 14, 2009

(54) Best pre-match routing (of foreign exchange orders)

(76) Inventor: Franck Rene Mikulecz, Dublin 2 (IE)

Correspondence Address: K&L Gates LLP, STATE STREET FINANCIAL CENTER, One Lincoln Street, BOSTON, MA, 02111-2950, US

(21) Appl. No.: 11/985,051

(22) Filed: Nov. 13, 2007

(51) Int. Cl. G06Q 40/00; G06Q 30/00

(52) U.S. Cl. 705/37

(57) ABSTRACT

This invention relates to a method of matching Foreign Exchange orders in a system comprising a market taker, a third party system and a matching host system. The method comprises the steps of the market taker sending an order to the matching host system and the matching host determining whether the order can be filled. If the order cannot be filled immediately, the matching host duplicates the order and sends a copy of the order to the third party system. Once one of the third party and the matching host become able to fill the order, the matching host cancels the order from the other of the third party and the matching host. It is possible to commit to orders in the matching host and roll back those orders if they have been fully or partially filled in the third party system so that orders are not filled twice.

### FIELD OF THE INVENTION

This invention relates to a method of matching Foreign Exchange orders. More specifically, this invention relates to a method of matching Foreign Exchange orders in a system comprising at least one market taker, a third party system and a matching host system, the matching host system comprising at least one market maker, a matching host and an order book. The invention particularly relates to the field of Interbank foreign currency exchange.

### BACKGROUND OF THE INVENTION

Foreign Exchange has been traded in the Interbank Foreign Exchange market for several years. The Interbank Foreign Exchange market covers a range of products like Spot Foreign Exchange, Foreign Exchange Forwards and Foreign Exchange Swaps.

Generally speaking, the Foreign Exchange markets participants may be divided into two separate groups, market makers and market takers. Market makers are concerns, usually banks, which offer two-way tradable prices on a constant basis. For example, in a Foreign Exchange transaction, banks offer prices to buy a currency at a given exchange rate and also offer prices to sell the currency at another given exchange rate. Market takers, on the other hand, tend to be individuals or concerns that only periodically use the Foreign Exchange markets. Market takers generally liaise with the market makers through a broker. Electronic brokers operate a matching host system to compare the prices of a number of market makers and determine the best price for the market taker before completing the transaction on behalf of the market taker.

It is highly desirable for the broker to be able to obtain the best possible price for the market taker. However, it is quite common for two or more different market makers to offer the same price and in those circumstances the broker may have affiliations or agreements with preferred market makers that it may wish to do business with. In those circumstances, it is essential that the broker may recognize the preferred market maker and make the trade with them if at all possible. This is often quite difficult to do due to the fact that the markets may move very rapidly and the prices offered by the market makers may change continuously.

In addition to the above, speed of execution of a trade is of the utmost importance as the positions may change practically instantaneously and it is vital that if a desired rate becomes available, that it is availed of. Typically, the margins in a Foreign Exchange may be relatively tight and therefore it is important to be able to take advantage of any arbitrage in the market. This may only be achieved through very quick execution of the trades. It is an object of the present invention to provide a method that overcomes at least some of these difficulties and that allows foreign exchange orders to be filled in a quick and efficient manner.

### SUMMARY OF THE INVENTION

According to the present invention there is provided a method of matching Foreign Exchange orders in a system comprising at least one market taker, a third party system and a matching host system, the matching host system comprising at least one market maker, a matching host and an order book, the method comprising the steps of:

the market taker transmitting an order to the matching host system;

the matching host storing the order in the order book, determining whether the order can be filled and on the order being unable to be filled at that time, the matching host duplicating the order and transmitting a duplicate copy of the order to a third party system; and

on one of the third party system and the matching host subsequently becoming able to fill the order, the matching host cancelling the order from the other of the third party system and the matching host system.

By having such a method, it is possible to ensure that an order is matched as soon as possible and if the order cannot be matched at that moment in time, the order is duplicated and sent to a third party system. This duplication is particularly important as it allows for the order to be placed in a number of different systems so that as soon as a particular position becomes available in one of the systems, it may be taken advantage of. Furthermore, the method provides for cancellation of the duplicate or original order depending on which is filled first thereby preventing the order being filled twice which is also of significant importance. Heretofore, the duplication of an order was not possible due to the risk of double matching. However, the method according to the present invention overcomes this problem.

In another embodiment of the present invention there is provided a method in which, on the matching host subsequently becoming able to fill the order, the matching host performs the steps of:

provisionally committing the order;

transmitting a confirmation message to the market taker; and

sending a cancellation message to the third party system.

By provisionally committing the order, the method ensures that the order can be carried out in the matching host system however if the order has already been carried out either partially or in full in another system, it is possible to cancel the order in the matching host system and ensure that the order is not filled twice. Furthermore, the market taker is simply informed that the order is already fulfilled and it is not of a concern to them exactly with whom the trade is executed with.

In a further embodiment of the present invention there is provided a method in which on the third party system accepting the cancellation of the order, the third party system transmits a confirmation message to the matching host and the matching host thereafter fully commits the order and fills the order in the matching host system. Once the matching host is aware that the order has been cancelled in the third party system, the matching host is able to fill the order that was provisionally filled with a preferred market maker.

In one embodiment of the present invention there is provided a method in which once the matching host has filled the order, the matching host informs the market maker and clears the order from the order book.

In another embodiment of the present invention there is provided a method in which on the third party system rejecting the cancellation of the order having already filled the entire order, the third party system transmits a rejection message to the matching host and the matching host rolls back the order in the matching host system, clears the order from the order book and accepts the fill from the third party system. This is seen as advantageous as the matching host will not fill the order twice. The market taker has been informed that the trade has been carried out and they are not concerned with whom the trade has been carried out with. The trade has been carried out in the fastest manner possible. The matching host will be able to roll back the order in its own system to ensure that the order is not filled twice. In this way, the matching host will also be able to get the desired price for the customer if it becomes available through a third party.

In a further embodiment of the present invention there is provided a method in which on the third party system rejecting the total cancellation of the order having already filled the order in part, the third party transmits a partial rejection message to the matching host and the matching host accepts the filled part of the order by the third party system, rolls back that filled part of the order in the matching host system, fully commits the remainder of the order and fulfills the remainder of the order in the matching host system. This is seen as particularly useful as the matching host will be able to fulfill some of the order with its preferred market makers that offer prices to the matching host, even if some of the trade has already been completed. In this way, the matching host may ensure that it is able to obtain the maximum amount of business and highest possible volume of trades for the preferred market maker.

In one embodiment of the present invention there is provided a method in which, on the third party system subsequently becoming able to match the order, the third party system performs the steps of:

filling the order;

notifying the matching host system that the order has been filled;

and on receipt of the notification from the third party system, the matching host system subsequently performs the steps of:

notifying this market taker that the order has been filled; and

clearing the order from the order book.

In another embodiment of the present invention there is provided a method in which, on the matching host determining that the order can be filled immediately, the matching host determines where the best price for the order is available. This will enable the matching host to fulfill an order immediately if a suitable price is available to satisfy the order. The matching host can take advantage of the best price on offer in the market.

In a further embodiment of the present invention there is provided a method in which, on the matching host determining that the best price for the order is available in the matching host system, the matching host fully commits the order and notifies both the market taker and the market maker that the order has been filled.

In one embodiment of the present invention there is provided a method in which, on the matching host determining that the best price for the order is available in the third party system, the matching host transmits the order to the third party system.

In another embodiment of the present invention there is provided a method in which, subsequent to transmitting the order to the third party system, the matching host awaits confirmation from the third party system and on receipt of confirmation, the matching host notifies the market taker that the order has been filled.

In one embodiment of the present invention there is provided a method in which, on neither of the matching host and the third party system being able to fill the order within a period of time determined by the user, the matching host cancels the order with the third party system and deletes the order in the order book.

In another embodiment of the present invention there is provided a method in which the order is one of an “at market”, limit, stop, conditional and “if done” order.

In a further embodiment of the present invention there is provided a method in which the method comprises the initial step of the matching host aggregating the prices of at least one market maker and one third party system and making the aggregation of the prices accessible to market takers for review. This is seen as particularly beneficial for the market takers as they can see the best prices of a number of market makers currently available to them and can make decisions based on the best current prices offered by a number of the market makers.

In one embodiment of the present invention there is provided a method in which the matching host has access to a list of the third party systems arranged in the list based on their suitability to fulfill a particular order and the matching host transmits the duplicate copy of the order to the most suitable third party system from the list.

In another embodiment of the present invention there is provided a method in which the list of third party systems is ordered using a statistical analysis of the third party systems previous performance for that type of order.

### BRIEF DESCRIPTION OF THE DRAWINGS

The invention will now be more clearly understood from the following description of some embodiments thereof, given by way of example only, with reference to the accompanying drawings, in which:—

FIG. 1 is a diagrammatic representation of a system in which the method according to the present invention may be carried out;

FIG. 2 is a flow diagram of the method steps of the method according to the present invention; and

FIGS. 3(a) and 3(b) are flow diagrams of the method steps of the method according to the present invention.

### DETAILED DESCRIPTION OF THE DRAWINGS

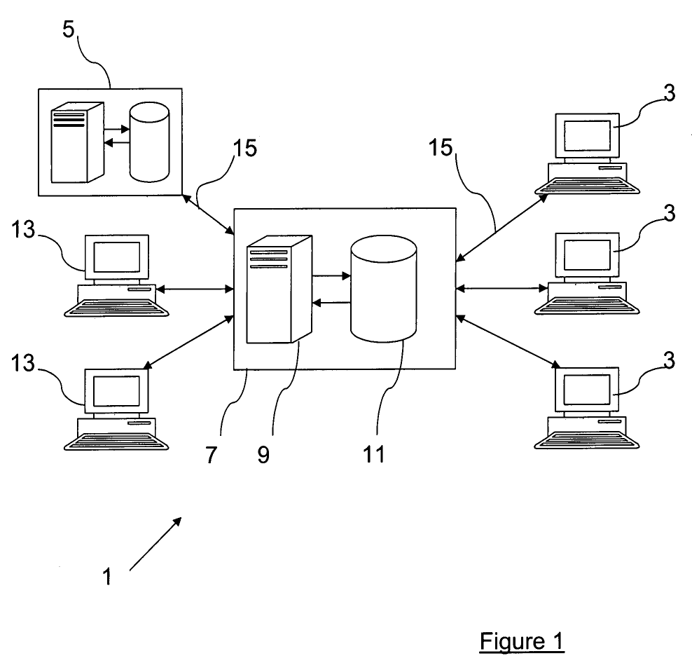

Referring to the drawings and initially to FIG. 1 thereof there is shown a system, indicated generally by the reference numeral 1, comprising a plurality of market takers 3, a third party system 5 and a matching host system 7. The matching host system comprises a matching host 9, an order book, represented by way of database 11, and a plurality of market makers 13. The market takers 3, third party system 5 and market makers 13 are all in communication with the matching host system 7 by way of communication links 15. The communication links 15 may be dedicated channels for the transfer of data to and from the matching host system 7 including but not limited to internet links, dedicated cables, ISDN lines or wireless communication channels.

In use, the matching host receives pricing information from each of the market makers 13. The matching host system may itself comprise a market maker providing pricing information. The matching host aggregates the pricing information from the plurality of market makers to determine the best price offered by each of the market makers and makes the aggregated pricing information available to the market takers 3. The market takers access the aggregated pricing information from the matching host over communication links 15 which are typically communication links through the internet (not shown) and the matching host in turn comprises a web server (not shown) to provide access to the market takers to the pricing information through the internet. Various protections such as those commonly known in the art may be incorporated to restrict access to the matching host system to certain market takers and prevent general access to the matching host system and pricing information. These protections would be well known to the skilled addressee and further elaboration on the protective measures is deemed unnecessary as they are not central to the present invention.

The market takers 3 make orders over the communication links 15 with the matching host system 7. The matching host 9 stores the orders in the order book 11 which is essentially a searchable database. The matching host 9 determines whether the order can be completed immediately either through a price being offered by the matching host system market makers 13 or a price being offered by the third party system. If the matching host can satisfy the order immediately, it does so. If the best price is being offered by the matching host system, the matching host uses that price to satisfy the order. The matching host commits the transaction and informs the market taker, otherwise referred to as a customer, and the market maker of the order having been completed. The order book 11 is then cleared. If the best price is offered by a third party system 5, the matching host sends the order to the third party system 5 and awaits confirmation from the third party system. If confirmation of the order is received from the third party system, the matching host informs the market taker that the order has been fulfilled and clears the order book of the order. Finally, if it is not possible to match the order at that time, or the order was sent to a third party system and no confirmation was received, the order is treated as a limit order unless otherwise specified by the order type. The procedure used to satisfy limit orders will be described in detail below.

The limit orders are orders that are not matchable at that moment in time and these orders are duplicated. The original of the order is stored in the order book 11 and a duplicate is sent to a third party system 5. Although only one third party system 5 is shown in FIG. 1, it will be understood that there may be numerous third party systems. The choice of third party system that the duplicate order is sent to may be taken from a list of potential third party systems stored in the database 11 and this list may be formed based on preferences of the creator of the list, previous experience of the third party system for that particular type of trade, statistical analysis of the third party system based on previous performance in a particular type of trade or any other reason for listing the third party systems. The order is therefore stored in two or more systems, the matching host system and the third party system. As soon as it is possible to satisfy the order in one of the systems, the order is satisfied and the market taker is notified of the order being completed. Depending on whether the order was completed in the matching host system or the third party system, the duplicate order or the original order in the order book are cleared respectively. By having such a method, the orders are not filled twice and the orders are satisfied as soon as possible in accordance with the market takers requirements.

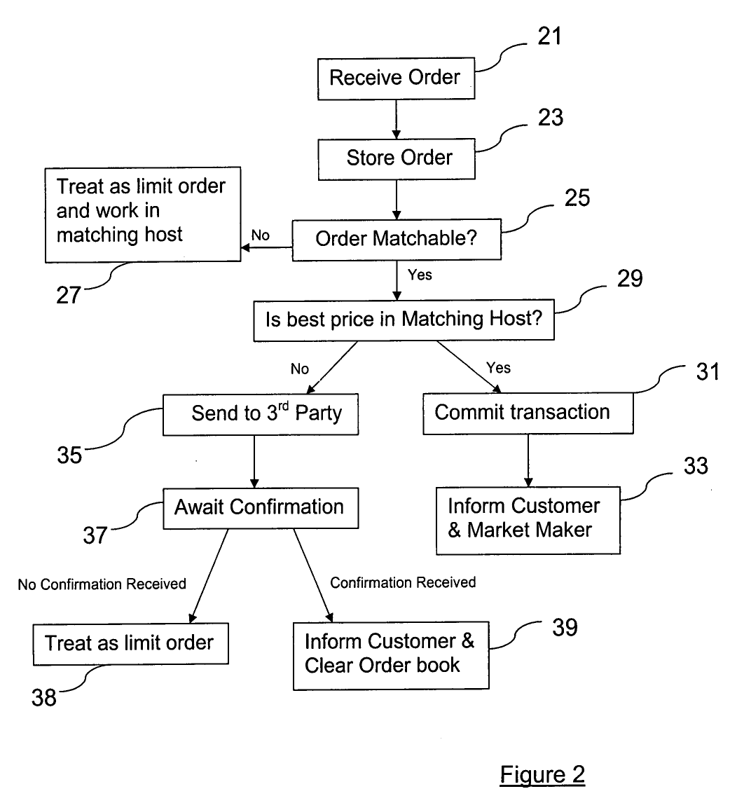

Referring to FIG. 2 of the drawings, there is shown a flow diagram of the handling of an order by the matching host 9. In step 21, the matching host system receives an order from a market taker. In step 23, the matching host 9 stores the order in the order book 11 before determining in step 25 whether the order is immediately matchable. If the order is not matchable immediately, the order is treated as a limit order in step 27. If the order is matchable, then the matching host determines in step 29 whether the best price is being offered by the matching host system 9. The matching host system has already aggregated all of the prices offered by market makers 13 with which it is associated. The best price offered by the matching host system 7 is used if possible. If the best price is being offered by the matching host system, the matching host 9 commits the transaction in step 31 and in step 33 the matching host 9 informs both the market taker (customer) 3 and the market maker that offered the best price of the trade in step 33. If, however, the best price is being offered by a third party system 5, the matching host sends the order to the third party in step 35 and in step 37 awaits confirmation of the order from the third party system. If confirmation is received, the matching host 9 sends an order confirmation to the market taker and clears the order book in step 39. If however, confirmation is not received within a predetermined time limit, the order is treated as a limit order in step 38.

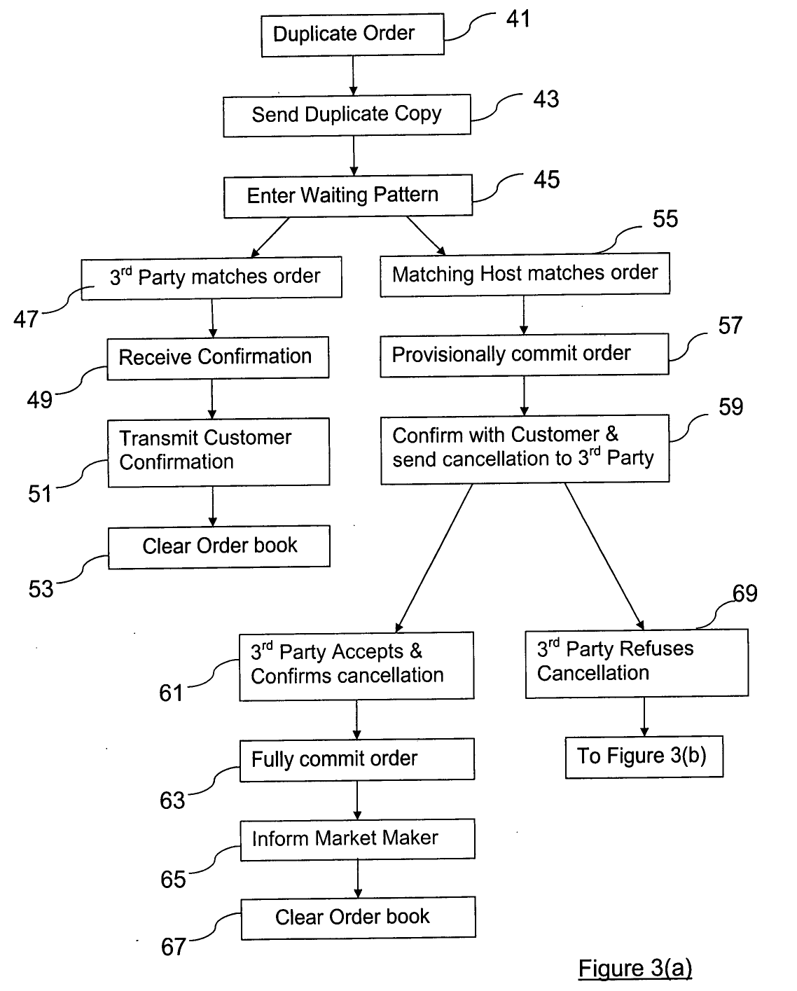

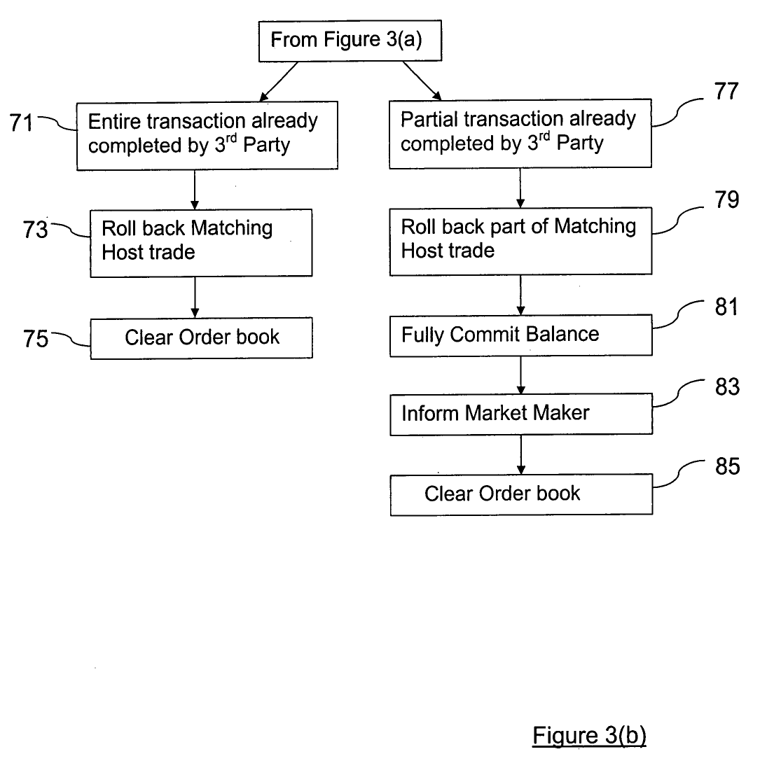

Referring to FIGS. 3(a) and 3(b) of the drawings, there is shown a further flow diagram of the method according to the present invention. Specifically, FIGS. 3(a) and 3(b) show the steps taken to handle a limit order or an order that cannot be fulfilled immediately. In step 41, the order is duplicated and in step 43 the duplicate copy order is sent to a third party system 5 over communication link 15. The method then enters a waiting pattern that can be any time period from of the order of 0.1 seconds up to a number of days or weeks. During the waiting pattern, both the third party system 5 and the matching host system 7 are monitoring the order and if the opportunity arises to fulfill the order, they will do so at the earliest opportunity. If the third party system has the opportunity to match the order first, the method proceeds to step 47 in which the order is matched by the third party system 5. The third party sends an order confirmation to the matching host and in step 49, the matching host receives the confirmation and in step 51, the matching host transmits an order completion confirmation to the market taker. Finally, in step 53, the matching host clears the order book.

If, during the waiting pattern in step 45, the matching host system 7 is able to match the order and it has not received an order confirmation from the third party system, the matching host 9 matches the order in step 55. In step 57, the matching host 9 provisionally commits the order and in step 59, the matching host 9 sends a confirmation of the order completion to the market taker and simultaneously sends a cancellation message to the third party system, cancelling the duplicate order previously sent to the third party system in step 43 above. In this way, the market taker has been informed that the order has been met and therefore one side of the transaction has been fulfilled but the order has not yet been finalized by the matching host. This is most relevant and important.

If the third party system has not also either partially or totally filled the order prior to receiving the cancellation message, the third party system will accept the cancellation of the order and will confirm the cancellation of the order to the matching host 9. On receipt of this confirmation, the matching host 9 will fully commit the order in the matching host system in step 63 and inform the relevant market maker 13 of the transaction being carried out in step 65. In this way, the market maker 13 forming the other side of the transaction is notified subsequent to the market taker and the other side of the transaction is fulfilled. Finally, the order book of the matching host is cleared in step 67.

In certain circumstances, the third party system will refuse the cancellation of the duplicate order. Referring specifically to FIG. 3(b), there are essentially two scenarios in which the third party system would wish to refuse the cancellation. These are that the entire transaction has already been completed by the third party system prior to the third party system receiving the cancellation message, as shown in step 71, and the third party system 5 has completed only part of the transaction/order already prior to the third party system receiving the cancellation message from the matching host 9, as shown in step 77. If, in step 71, the third party system has already completed the entire transaction, the matching host will roll back the matching host order in step 73. The matching host order has only been provisionally committed to in step 57 and therefore it is possible to roll back or in other words cancel the provisionally committed order. This is made possible by the provisional matching method which is built into the system instead of executing the order immediately. The order book of the matching host is cleared in step 75. The market taker who has already received a confirmation that his order has been fulfilled, will have done so in this case entirely by the third party system.

If in step 77, the third party system has only partially completed the order when it receives the cancellation message, the third party system will stop at that point and cease completing the trade. However, at this point some of the trade has already been executed and there is still part of the order that must be fulfilled. In step 79, the matching host 9 determines the amount of the order that has been completed and rolls back that amount of the order from the order that was provisionally committed to in step 57. In step 81, the matching host 9 determines the balance of the order that must be completed and the matching host fully commits this balance in the matching host system 7. In step 83, the relevant market maker is informed of the trade and in step 85, when the trade is completed, the order book is cleared. In this way, the order is effectively split over two market makers in two different systems, one in the third party system 5 and one in the matching host system 7. By doing this, all of the value of the trade is not lost to the matching host system and the market makers associated therewith and the market taker is not adversely affected in any way.

It will be understood that various modifications may be made to the system and the method without deviating from the spirit of the invention. For example, the matching host system may comprise a number of market makers operating in unison proximal to the matching host or alternatively one or more of the market makers may be located remote from the matching host system as shown. Furthermore, it will be understood that in such a system and method, various components may be located remote from each other and indeed various components may be located in other jurisdictions. For example, the matching host system comprises a matching host which may be located in one jurisdiction, and an order book which comprises a database 11 which may be located adjacent to or remote from the matching host 9 in the same or another jurisdiction. The matching host and the database may be running on the same machine or alternatively may be running on entirely separate devices.

The market makers will typically push their market information to the matching host system 7 for the matching host system to aggregate the prices offered. By aggregate, what is meant is that the most preferable rates offered by all the market makers are given to the market takers. It will be further understood that various parts of the present invention will comprise computer code running on or in a computer and accordingly the present invention is also deemed to extend to computer code comprising program instructions for causing a computer to execute one or more of the steps of the present method. The computer code may be stored on or in a carrier which may be any suitable medium including but not limited to a floppy disc, a RAM, a ROM, and CD, DVD, memory stick, flash stick or other memory device or carrier such as a carrier wave carrying the program code.

In this specification the terms “comprise, comprises, comprised and comprising” and the terms “include, includes, included and including” are all deemed totally interchangeable and should be afforded the widest possible interpretation.

The invention is in no way limited to the embodiments hereinbefore described but may be varied in both construction and detail within the scope of the claims.

1. A method of matching Foreign Exchange orders in a system comprising at least one market taker, a third party system and a matching host system, the matching host system comprising at least one market maker, a matching host and an order book, the method comprising the steps of:
the market taker transmitting an order to the matching host system;
the matching host storing the order in the order book, determining whether the order can be filled and on the order being unable to be filled at that time, the matching host duplicating the order and transmitting a duplicate copy of the order to a third party system; and
on one of the third party system and the matching host subsequently becoming able to fill the order, the matching host cancelling the order from the other of the third party system and the matching host system.

2. The method as claimed in claim 1, in which, on the matching host subsequently becoming able to fill the order, the matching host performs the steps of:
provisionally committing the order;
transmitting a confirmation message to the market taker; and
sending a cancellation message to the third party system.

3. The method as claimed in claim 2 in which on the third party system accepting the cancellation of the order, the third party system transmits a confirmation message to the matching host and the matching host thereafter fully commits the order and fills the order in the matching host system.

4. The method as claimed in claim 3 in which once the matching host has filled the order, the matching host informs the market maker and clears the order from the order book.

5. The method as claimed in claim 2, in which on the third party system rejecting the cancellation of the order having already filled the entire order, the third party system transmits a rejection message to the matching host and the matching host rolls back the order in the matching host system, clears the order from the order book and accepts the fill from the third party system.

6. The method as claimed in claim 2, in which on the third party system rejecting the total cancellation of the order having already filled the order in part, the third party transmits a partial rejection message to the matching host and the matching host accepts the filled part of the order to be filled by the third party system, rolls back that filled part of the order in the matching host system, fully commits the remainder of the order and fulfills the remainder of the order in the matching host system.

7. The method as claimed in claim 1, in which, on the third party system subsequently becoming able to match the order, the third party system performs the steps of:
filling the order;
notifying the matching host system that the order has been filled;
and on receipt of the notification from the third party system, the matching host system subsequently performs the steps of:
notifying this market taker that the order has been filled; and
clearing the order from the order book.

8. The method as claimed in claim 1, in which, on the matching host determining that the order can be filled immediately, the matching host determines where the best price for the order is available.

9. The method as claimed in claim 8, in which, on the matching host determining that the best price for the order is available in the matching host system, the matching host fully commits the order and notifies both the market taker and the market maker that the order has been filled.

10. The method as claimed in claim 8, in which, on the matching host determining that the best price for the order is available in the third party system, the matching host transmits the order to the third party system.

11. The method as claimed in claim 10, in which, subsequent to transmitting the order to the third party system, the matching host awaits confirmation from the third party system and on receipt of confirmation, the matching host notifies the market taker that the order has been filled.

12. The method as claimed in claim 1, in which, on neither of the matching host and the third party system being able to fill the order within a period of time determined by the user, the matching host cancels the order with the third party system and deletes the order in the order book.

13. The method as claimed in claim 1, in which the order is one of an “at market”, limit, stop, conditional and “if done” order.

14. The method as claimed in claim 1, in which the method comprises the initial step of the matching host aggregating the prices of the at least one market maker and one third party system and making the aggregation of the prices accessible to market takers for review.

15. The method as claimed in claim 1, in which the matching host has access to a list of the third party systems arranged in the list based on their suitability to fulfill a particular order and the matching host transmits the duplicate copy of the order to the most suitable third party system from the list.

16. The method as claimed in claim 15, in which the list of third party systems is ordered using a statistical analysis of the third party systems previous performance for that type of order.

17. A method of matching Foreign Exchange orders in a system comprising at least one market taker, a third party system and a matching host system, the matching host system comprising at least one market maker, a matching host and an order book, the method comprising the steps of:
the market taker transmitting an order to the matching host system;
the matching host storing the order in the order book, determining whether the order can be filled and on the order being unable to be filled at that time, the matching host duplicating the order and transmitting a duplicate copy of the order to a third party system; and
on one of the third party system and the matching host subsequently becoming able to fill the order, the matching host cancelling the order from the other of the third party system and the matching host system;
on the matching host subsequently becoming able to fill the order, the matching host performs the steps of:
provisionally committing the order;
transmitting a confirmation message to the market taker; and
sending a cancellation message to the third party system; and

18. The method as claimed in claim 17 in which on the third party system subsequently becoming able to match the order, the third party system performs the steps of:
filling the order;
notifying the matching host system that the order has been filled;
and on receipt of the notification from the third party system, the matching host system subsequently performs the steps of:
notifying this market taker that the order has been filled; and
clearing the order from the order book.

19. The method as claimed in claim 17, in which the matching host has access to a list of the third party systems arranged in the list based on their suitability to fulfill a particular order and the matching host transmits the duplicate copy of the order to the most suitable third party system from the list.

20. A method of matching Foreign Exchange orders in a system comprising at least one market taker, a third party system and a matching host system, the matching host system comprising at least one market maker, a matching host and an order book, the method comprising the steps of:
the market taker transmitting an order to the matching host system;
the matching host storing the order in the order book, determining whether the order can be filled and on the order being unable to be filled at that time, the matching host duplicating the order and transmitting a duplicate copy of the order to a third party system; and
on one of the third party system and the matching host subsequently becoming able to fill the order, the matching host cancelling the order from the other of the third party system and the matching host system;
on the matching host subsequently becoming able to fill the order, the matching host performs the steps of:
provisionally committing the order;
transmitting a confirmation message to the market taker; and
sending a cancellation message to the third party system; and
in which on the third party system rejecting the total cancellation of the order having already filled the order in part, the third party transmits a partial rejection message to the matching host and the matching host accepts the filled part of the order to be filled by the third party system, rolls back that filled part of the order in the matching host system, fully commits the remainder of the order and fulfills the remainder of the order in the matching host system.
